(19) United States
(12) Patent Application Publication
(10) Pub. No.: US 2015/0352770 A1
(43) Pub. Date: Dec. 10, 2015

(54) Screw Element and Method of Producing Screw Elements

(71) Applicant: Carl Aug. Picard GmbH, Remscheid (DE)

(72) Inventor: Michael Busenbecker, Remscheid (DE)

(73) Assignee: Carl Aug. Picard GmbH

(21) Appl. No.: 14/729,852

(22) Filed: Jun. 3, 2015

(30) Foreign Application Priority Data
Jun. 4, 2014 (EP) 14171134.1

(51) Int. Cl. B29C 47/40; B01F 15/00; B01F 7/00; B22F 3/105; B29C 47/60

(52) U.S. Cl. CPC B29C 47/402; B22F 3/1055; B29C 47/60; B01F 7/00416; B01F 15/00487; B22F 2003/1058; B33Y 10/00

(57) ABSTRACT

A production method for screw elements (1) with a screw body (3) with an axially through-opening (5) with internal gearing (7) for mounting on a support shaft and an outer contour (9) for closely meshing twin-shaft extruders. A metallic powder material (13) is arranged step by step in layers in the direction of a production axis (Z-Z) on a work platform (11), wherein a laser beam (19) for each layer of the screw element (1) irradiates the powder material (13) according to the data of a three-dimensional model in a specific irradiation sequence at specific sites of the layer. The powder material (13) is melted, fully in places, and bonded with the directly underlying layer, so that after hardening of the layers, a complete, stable screw body (3) is produced. Further, the invention relates to a screw element produced in this way.

### CROSS-REFERENCE TO RELATED APPLICATIONS

This invention claims priority to European Patent Application No. 14171134.1, filed Jun. 4, 2014.

### FIELD OF THE INVENTION

The invention relates to a method for producing screw elements, in particular, for closely meshing twin-shaft extruders rotating in the same direction. In addition, the invention relates to a screw element; in particular, for closely meshing twin-shaft extruders rotating in the same direction, comprising a screw body with an axially running through-opening with an internal gearing for mounting on a support shaft and with an outer contour for provision of an extruder function.

### BACKGROUND

Screw elements of the above described general type are used in various industrial applications, for example, as part of twin-shaft extruders, wherein one focus is on the processing of plastics. The screws used in twin-shaft extruders have a modular structure and consist of a support shaft and individual screw elements. The geometry of the screw elements is designed according to the process-technology tasks and functions of the twin-shaft extruder, and they are mounted next to one another in a defined configuration in the axial direction on the support shaft. The screw elements are divided into the main groups of conveying elements, kneading elements, barrier elements, mixing elements, and special elements, which differ in particular in their outer geometry, which is adapted to the respective function.

To date, production of the screw elements, regardless of the type, size, and function, is based on the combination of classical machining methods, such as sawing, turning, milling, whirling, and grinding for the external geometry. For installation on the support shaft, depending on the machine manufacturer and construction size, the screw elements have different inner profiles or internal gearings, which implement force transmission between the support shaft and the screw element. These internal gearings for known screw elements are normally produced by means of mold-dependent production methods such as keyseating, slotting, and or erosion machining.

Ferrous and non-ferrous alloys are used as the materials for known screw elements; they are selected according to the type of wear, in particular due to abrasion and/or corrosion. Here, materials produced both by melting metallurgy and powder metallurgy may be used. In particular, heavy steels or hot isostatic press (HIP) compound steels are used. In the HIP compound, steels up to HRC 66 are machined. These are configured with a soft cylindrical internal core, but for smaller diameters, this is very costly; in particular, for diameters of less than 30 mm it is not regarded as economical. For very small diameters of less than 20 mm, production in a HIP compound is no generally feasible, as in particular the soft cylindrical internal core would be too thin to allow adequate force transmission through the inner profile, and the processing of high-strength compact materials with methods such as slotting and broaching, for example, with thrusts of more than 1200 N for provision of the internal profiles is not considered technically feasible. Such materials tear and break due to poor viscosity.

A typical production process of known screw elements, in particular comprised of the steps of sawing, HIP core centering, pre-turning, profile grinding, milling, slotting of the internal gearing, hardening, annealing, finish grinding, and sand blasting.

Disadvantages of the known screw elements are that the production process is complex and costly. In addition, due to the use of classical machining methods and mold-dependent production methods, smaller diameters and certain outer and inner geometries of the screw elements can be produced only with great difficulty or not at all when using certain hard alloys.

In addition, due to the use of hard alloys in combination with the previously used production method, the production of cooling channels inside the screw elements is very complex, and if possible at all, only in parallel to the axis, so that cooling of the outer contour is not uniform.

The task of the invention is to avoid the aforementioned disadvantages and to provide a production method for screw elements, in particular with small diameters, which can be carried out in a simpler and more economical manner, and which offers more flexibility for the formation of the internal gearing and the outer contour, and the cooling of the screw elements.

### SUMMARY AND INTRODUCTORY DESCRIPTION OF INVENTION

The above described task is achieved in that a metallic powder material is arranged step by step in layers in the direction of a production axis on a work platform, wherein a laser beam for each layer of the screw element irradiates the powder material according to the data of a three-dimensional model in a specific irradiation sequence at specific sites of the layer, wherein hereby the powder material is completely melted in places, and is bonded with the directly underlying layer, so that after hardening of the layers, a complete, stable screw body is produced according to the three-dimensional model. By means of a method of this type, classical machining methods and mold-dependent production methods for producing the screw elements may be dispensed with. In this way new geometries for the internal gearing and for the outer contour of the screw elements can be produced in a simple manner. In particular this allows production of screw elements that are made entirely of hard alloys. This allows a more economical production of screw elements.

It is especially advantageous with such a method if the sites of a layer of the powder material to be irradiated are divided up into plots in a grid pattern, wherein the laser beam irradiates the different plots of a layer on the basis of a random irradiation sequence. In particular, the layers to be irradiated are divided into irradiation zones running radially with respect to the production axis, wherein the sequence of irradiation of the irradiation zone occurs radially from the inside out. This allows better distribution of the heat energy during the production process and prevents uncontrolled heating of the screw element during production. In addition, this prevents fusion in particularly small structures, such as with internal gearing. It also reduces the risk of a heat-induced warping of the structures of the screw element during the production phase.

In particular, in one embodiment of the method in accordance with this invention is using a laser beam in addition to the screw element, supporting structures are produced in the layers so that the screw element to be produced in the powder material during production is supported especially on the work platform. This way, the supporting structures are advantageously connected to the outer contour and/or the lower faces of the screw element so that during the melting process, they conduct the heat energy that is produced out of the screw element.

In advantageous embodiments of the method, the powder material is preferably a powder-like, high-strength, high-speed steel, in particular with high carbide proportions (chromium carbide, vanadium carbide, tungsten carbide), or a powder-like cobalt-chromium or nickel-chromium-molybdenum hard alloy. This allows especially hard and tough outer contours of the screw elements.

In addition, it is the task of the invention to provide screw elements, in particular with small diameters, which can be produced as simply and economically as possible, that have improved internal gearing, improved cooling, and improved outer contours.

The task is achieved in that a screw element, in particular for closely meshing twin-shaft extruders rotating in the same direction, employing a screw body with an axially running through-opening with an internal gearing for mounting on a support shaft and with an outer contour for provision of an extruder function, is provided according to the inventive method described above.

In an especially advantageous embodiment, at least one axially running inner cooling channel is arranged in the screw body, which cooling channel runs in a uniform radial distance with respect to a surface of the outer contour or to a surface of an internal gearing and follows the course of the surface. This allows optimal cooling of the internal gearing and/or the outer contour, which ensures better service life in particular.

In a further embodiment of the present invention, the internal gearing is configured as involute gearing. In particular, the internal gearing is configured such that a power transmission of greater than or equal to 1,200 N/mm² may be achieved between the screw body and the support shaft. This allows better force distribution on the internal gearing so the higher forces can be transmitted and/or harder materials can be used.

### BRIEF DESCRIPTION OF THE DRAWINGS

Further advantageous embodiments of the invention arise from the following figure description, drawings, and dependent claims.

### Wherein:

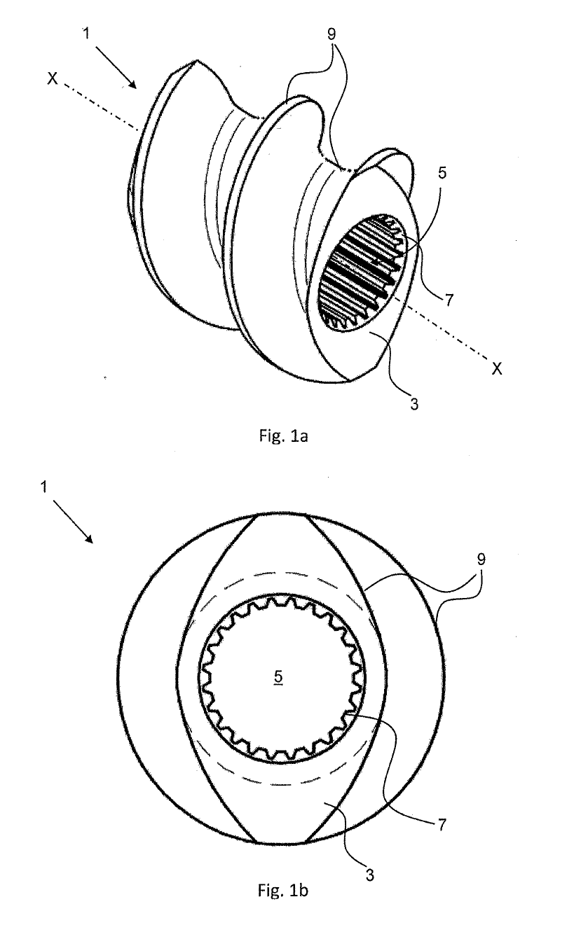

FIG. 1a is a three-dimensional view of a screw element according to the invention;

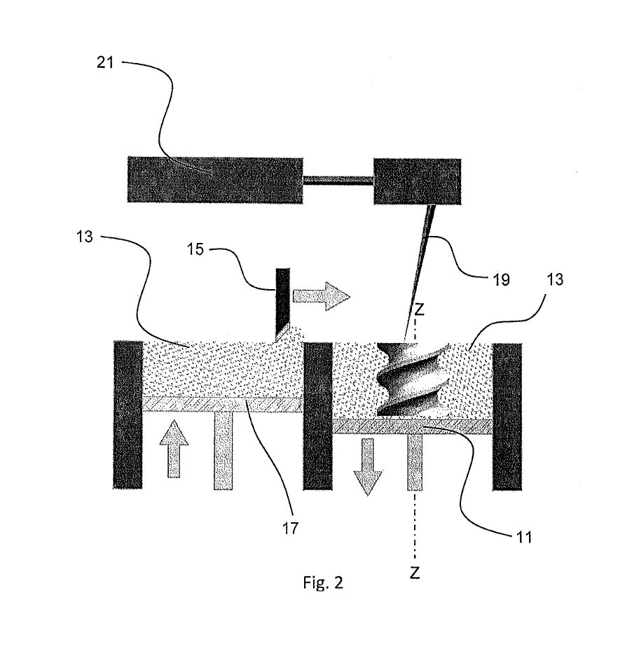

FIG. 1b is a top view of a face of the screw element according to the invention in FIG. 2a;

FIG. 2 is a sketch of a method according to the invention for production of screw elements;

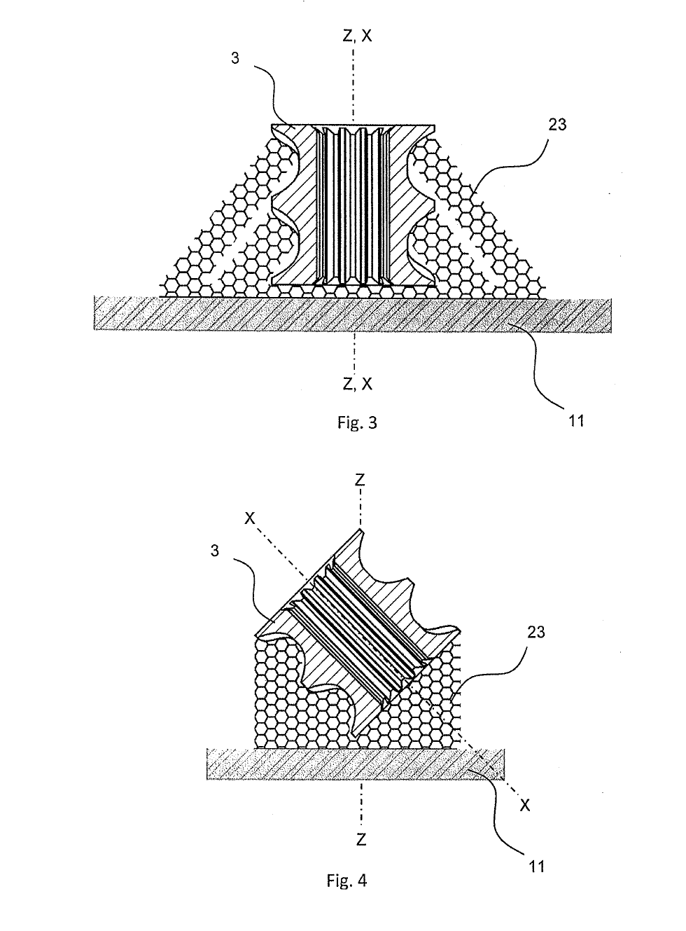

FIG. 3 is a sectional view of a screw element according to the invention in a 90° arrangement with supporting structures;

FIG. 4 is a sectional view of a screw element according to the invention in a 45° arrangement with supporting structures; and

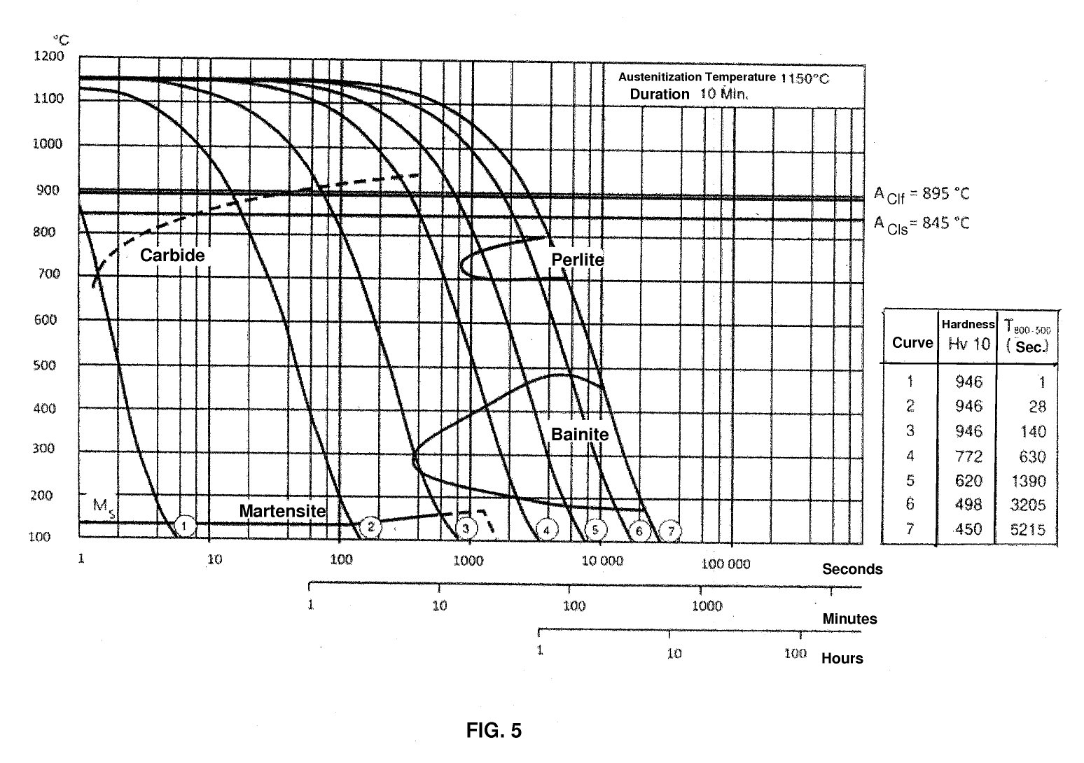

FIG. 5 is time temperature transformation diagram for the material 1.3242.

### FURTHER DESCRIPTION OF INVENTION

FIGS. 1a and 1b show an embodiment of a screw element 1 according to the invention. In particular, the screw element 1 is configured for closely meshing, twin-shaft extruders, not shown, rotating in the same direction. The screw element 1 defines a screw body 3 with an axially running through-opening 5, with an internal gearing (spline) 7 for mounting on a support shaft, and with an outer contour 9 for providing an extruder function. For use with such a twin-shaft extruder, the screw element 1 along with another screw element is pushed axially onto the support shaft, not shown, of the twin-shaft extruder along the axis X-X of the screw element 1.

The internal gearing 7 of the through-opening 5 is advantageously configured as an involute gearing (in particular according to DIN 5480 of 2006 or alternatively ISO 4156 of 2005). This allows a higher force transmission to the support shaft. In particular, the internal gearing 7 is configured in such a way that a force transmission greater than or equal to 1200 N/mm² may be achieved between the screw body 3 and the support shaft. The profile deviation of the internal gearing 7 is advantageously in particular ±0.01 mm.

The outer diameter of the screw body 3, in particular the maximal outer diameter of the outer contour 9, is less than or equal to 58 mm, preferably less than or equal to 30 mm. The minimal outer diameter is in particular 12 mm. The maximal deviation of the contour separation, that is the separation of the surface of the outer contour 9 from the inner wall of the through-opening 5, is in particular ±0.05 mm.

The screw body 3 is formed using a single-component material advantageously. In particular, the single-component material is high-strength, high-speed steel, in particular with high carbide components (chromium carbide, vanadium carbide, tungsten carbide) or a cobalt-chromium or nickel-chromium-molybdenum hard alloy. The surface hardness of the screw body 3 is in the range of HRC 40 to HRC 70, preferably HRC 56 to HC 70 (according to the Rockwell hardness test, type HRC). In this way, during the extruder process, in particular, a higher abrasion resistance to hard fillers and strengthening agents such as glass fibers, graphite fibers, talcum, etc. and a higher corrosion resistance to water and acids such as HCL, HNO₃, HSO₃Cl etc., is achieved.

In an advantageous embodiment, not shown, of a screw element 1 according to the invention, the screw body 3 contains at least one axially running, internal cooling channel, which in particular runs with a uniform radial separation from a surface of the outer contour 9 or from a surface of the internal gearing 7 and follows the course of the surface. The leak tightness of the cooling system is in particular in a temperature range from 20° C. to 350° C.

Advantageously, the outer contour 9 is configured such that the surface of the outer contour 9 along the axial extent has the same separation, everywhere or at least approximately everywhere, with respect to a surface of a screw element 1 arranged in parallel, with identical outer contour 9.

According to the invention, the screw elements 1 are produced according to the following inventive method according to FIG. 2 in the form of a generative layer construction method by means of a work platform 11. With the method, a metallic powder material 13 is arranged step by step in layers, one over the other, in the direction of a production axis Z-Z. To this end, the powder material 13 is as a rule applied over the entire surface of the work platform 11 by means of a blade or roller. The powder material 13, at every step, is provided by raising a powder platform 17 as the supply container, and is conveyed to the work platform 11 by means of the blade 15.

For each layer of the screw element 1, a laser beam 19 of a laser 21 irradiates the powder material 13 according to the data of a three-dimensional model in a specific irradiation sequence and at specific sites on the layer. In this way, the powder material 13 is completely melted or re-melted in some places and bonds with the directly underlying layer. In this way, the energy that is delivered by the laser beam 19 is absorbed by the powder material 13 and results in a locally restricted sintering or fusing of particles with reduction of the overall surface. The work platform 11 is gradually lowered slightly in order to produce the next layer in the next step. After hardening of all layers, a complete stable screw body 3 is produced according to the three-dimensional model. The processing takes place layer for layer in the vertical direction, whereby undercut contours can also be produced.

In a preferred embodiment of the method, the sites of a layer of the powder material 13 to be irradiated are divided into plots in a grid manner, the laser beam 19 carrying out the irradiation of the various plots of one layer according to a random irradiation sequence. In particular, the layers to be irradiated are divided into irradiation zones running radially with respect to the production axis Z-Z, wherein the sequence of irradiation of the irradiation zones is radial, from the inside out. This allows better control of the heat development in the screw body 3 during the production process.

Moreover, in a further advantageous embodiment of the method according to the invention, in addition to the screw element 1, supporting structures 23 are melted into the layers, so that the screw element 1 to be produced is supported in the powder material 13 during production. Advantageously, the supporting structures 23 are connected to the outer contour 9 and/or the face of the screw element 1, which face is turned toward the build platform 11 so the supporting structures 23 during the melting process conduct the heat energy that is produced out of the screw element 1. The supporting structures 23 run in particular initially in a first section from the outer contour 9 parallel to the work platform radially away from screw body 3, and after that in a second section parallel to the production axis Z-Z to the work platform 11. The supporting structures 23 are in particular configured in a honeycomb shape. In an embodiment according to FIG. 3, the screw body 3 is produced in an arrangement such that the axis X-X of the screw element 1 is parallel to the production axis Z-Z. In a second embodiment according to FIG. 4, the screw body 3 is produced in an arrangement such that the axis X-X of the screw element 1 encloses a 45° angle with the production axis Z-Z. Basically, other angles are also conceivable, depending on the required heat removal. In this way, a good thermal connection to the work platform 11 and thus an effective removal of the heat after melting is possible. In particular this reduces heat-induced warping of the material during the cooling phase. This is especially important for the internal gearing, in order to assure good heat transmission.

The powder material 13 preferably is composed of a powder-like high-strength high-speed steel, in particular with high carbide proportions (chromium carbide, vanadium carbide, tungsten carbide) or a powder-like cobalt-chromium or nickel-chromium-molybdenum hard alloy. The layer thickness of the individual layers is in particular between 20 μm and 100 μm.

In an advantageous embodiment of the method according to the invention, the laser energy and the laser switch-on time of the laser beam 10 are adjusted to the powder material 13 and the layer density such that the powder material 13 in re-melted state is hardened directly from the production process of the screw body 3. The hardening takes place here according to DIN 17022 of October 1994. To this end, the laser parameters for the re-melting of the powder material 13 are to be chosen such that the process heat that arises in the component is removed via the powder bed or the support element from the support structures 23 at a quenching speed appropriate for the powder material 13 that is used. The required quenching speed may be found from the time-temperature transformation diagram for the respective powder material 13 that is used.

As an example, FIG. 5 shows the time-temperature transformation diagram for the material 1.3242 with continuous cooling, an austenitizing temperature of 1150° C., and a holding time of 10 minutes. Here, the laser parameters and the supporting structures 23 according to the invention are adjusted to one another such that a superficial/margin-zone or general hardness increase is achieved, up to a hardness level in a range from HRC 40 to HRC 70, in particular HRC 56 to HRC 70, in the screw body 3. The hardness increase here should occur only as a result of structural transformation, without alteration of the chemical composition. In this way, the additional process step of hardening by an additional heat treatment of the screw element 1 can be left out.

While the above description constitutes the preferred embodiment of the present invention, it will be appreciated that the invention is susceptible to modification, variation and change without departing from the proper scope and fair meaning of the accompanying claims.

1. A method for production of screw elements with a screw body with an axially running through-opening with an internal gearing for mounting on a support shaft and with an outer contour for provision of an extruder function, comprising:
arranging a metallic powder material step by step in layers in the direction of a production axis on a work platform one over the another, irradiating using a laser beam the powder material for each layer of the screw element according to the data of a three-dimensional model in a specific irradiation sequence at specific sites of the layer, wherein in this way the powder material is re-melted completely in places, and is bonded with the directly underlying layer such that after hardening of the layers, and wherein a complete, stable screw body is produced according to the three-dimensional model.

2. A method according to claim 1, further comprising the irradiating step is coined out by selecting sites of a layer of the powder material into plots in a grid pattern, wherein the laser beam irradiating the different plots of a layer according to a random irradiation sequence.

3. A method according to claim 1 further comprising in that irradiating the layers by dividing into irradiation zones radial to the production axis, wherein the sequence of irradiation of the irradiation zones is radial from the inside out.

4. A method according to claim 1 further comprising providing the powder material as a powder-like high-strength high-speed steel or a powder-like cobalt-chromium or a nickel-chromium-molybdenum hard alloy.

5. A method according to claim 1 further comprising forming the layer thickness of the individual layers between 20 μm and 100 μm.

6. A method according to claim 1 the laser beam forming in addition to the screw element, support structures in the layers, so that the screw element to be produced is supported in the powder material during production.

7. A method according to claim 6, further comprising forming the support structures connected to the outer contour or to the face of the screw element, which face is turned toward the work platform, such that during the melting process, they conduct the heat energy that is produced away from the screw element.

8. A method according to claim 6 further comprising the process temperature for laser re-melting and the support structures are configured such that the heat produced during re-melting for the powder material used is removed sufficiently rapidly, and an increase in hardness of the screw body is achieved up to a hardness level in a range of HRC 40 to HRC 70, superficially or generally.

9. A screw element for closely meshing twin-shaft extruders rotating in the same direction, produced in accordance with the method of claim 1.

10. A screw element according to claim 9, further comprising in that in the screw body having at least one axially running inner cooling channel which runs with a uniform axial separation with respect to a surface of the outer contour or to a surface of the internal gearing, and follows the course of the surface.

11. A screw element according to claim 9 further comprising in that the internal gearing is configured as an involute gearing.

12. A screw element according to claim 9 further comprising in that the outer contour is configured such that the surface of the outer contour everywhere along the axial extent has the same separation from the surface of a screw element arranged in parallel with the identical outer contour.

13. A screw element according to claim 9 further comprising in that the internal gearing is configured such that a force transmission greater than or equal to 1200 N/mm² may be achieved between the screw body and the support shaft.

14. A screw element according to claim 9 further comprising in that the outer diameter of the screw body is less than or equal to 58 mm.

15. A screw element according to claim 9 further comprising in that the surface hardness of the screw body lies in a range of HRC 40 to HRC 70.
